(19) United States
(12) Patent Application Publication
(10) Pub. No.: US 2025/0190930 A1
(43) Pub. Date: Jun. 12, 2025

(54) SYSTEMS AND METHODS FOR LOAD RECOMMENDATION USING PROFITABILITY SCORES IN A FREIGHT MANAGEMENT PLATFORM

(71) Applicant: Internet Truckstop Group LLC, Boise, ID (US)

(72) Inventors: Yi Hung Liu, Chicago, IL (US); Jeremy Greene, Mission Viejo, CA (US); Shubham Bhardwaj, Lewiston, NY (US)

(73) Assignee: Internet Truckstop Group LLC, Boise, ID (US)

(21) Appl. No.: 18/536,829

(22) Filed: Dec. 12, 2023

(51) Int. Cl. G06Q 10/0834

(52) U.S. Cl. CPC G06Q 10/08345

(57) ABSTRACT

Embodiments of a method for load recommendation using profitability scores in a freight management platform comprises receiving a search query associated with a carrier for loads posted on a loadboard, the search query including filters for one or more attributes of the loads; retrieving loads posted on the loadboard that satisfy the search query; retrieving previously logged data; determining a profitability score for each retrieved load based on the data, at least a part of the determining based on a subset of the data relevant to the search query; and displaying on a user interface, the retrieved loads matching the filters in the search query and arranged according to the profitability score. The profitability score represents hourly income from the corresponding load for the carrier. The profitability score of any one load varies among different carriers.

### TECHNICAL FIELD

The present disclosure relates to systems, techniques, and methods directed to load recommendation using profitability scores in a freight management platform.

### BACKGROUND

A freight management platform in the context of the transportation and logistics industry can include an online freight marketplace where shippers, brokers, and carriers can connect to arrange for transportation of freight. In such marketplaces, a loadboard facilitates matching of available freight with available carrier capacity, helping to streamline the process of finding and booking shipments for transportation. The loadboard serves as a digital marketplace where shippers and brokers can post their available freight loads, and carriers can search and bid on those loads for transportation. Similarly, carriers can also post their available truck capacity, and shippers and brokers can search for carriers to transport their goods. Loadboards often include real time load tracking, communication tools, and payment processing, helping to streamline the process of arranging transportation and managing freight shipments.

### BRIEF DESCRIPTION OF THE DRAWINGS

Embodiments will be readily understood by the following detailed description in conjunction with the accompanying drawings. To facilitate this description, like reference numerals designate like elements. Embodiments are illustrated by way of example, and not by way of limitation, in the figures of the accompanying drawings.

FIG. 1 is a simplified block diagram illustrating an example freight management platform for load recommendation using profitability scores, according to some embodiments of the present disclosure.

FIG. 2 is a simplified diagram illustrating example details of the freight management platform for load recommendation using profitability scores, according to some embodiments of the present disclosure.

FIG. 3 is a simplified block diagram illustrating other example details of the freight management platform for load recommendation using profitability scores, according to some embodiments of the present disclosure.

FIG. 4 is a scatter graph illustrating yet other example details of the freight management platform for load recommendation using profitability scores, according to some embodiments of the present disclosure.

FIG. 5 is a bar graph illustrating yet other example details of the freight management platform for load recommendation using profitability scores, according to some embodiments of the present disclosure.

FIG. 6 is a simplified block diagram illustrating yet other example details of the freight management platform for load recommendation using profitability scores, according to some embodiments of the present disclosure.

FIG. 7 is a simplified flow diagram illustrating example operations associated with the freight management platform for load recommendation using profitability scores, according to some embodiments of the present disclosure.

FIG. 8 is a simplified flow diagram illustrating other example operations associated with the freight management platform for load recommendation using profitability scores, according to some embodiments of the present disclosure.

FIGS. 9A-9B are a simplified flow diagram illustrating yet other example operations associated with the freight management platform for load recommendation using profitability scores, according to some embodiments of the present disclosure.

### DETAILED DESCRIPTION

### Overview

For purposes of illustrating the embodiments described herein, it is important to understand certain terminology and operations of technology networks. The following foundational information may be viewed as a basis from which the present disclosure may be properly explained. Such information is offered for purposes of explanation only and, accordingly, should not be construed in any way to limit the broad scope of the present disclosure and its potential applications.

Freight management platforms typically use a loadboard that connects shippers with carriers to facilitate booking of freight shipments. While loadboards can be valuable tools for matching available freight with trucking capacity, there are some challenges associated with their use. Some of the common issues faced by carriers include: competitive pricing pressures among carriers that drive down profit margins and impact quality of service; inability to factor for specific carrier-related constraints such as capacity, urgency or specialized services; variable quality of service in terms of incomplete or inaccurate shipping information on loadboards; limited data visibility to what is shown on the loadboard; capacity constraints when loadboards do not guarantee available capacity; hidden fees, which may impact carriers' profit margin or competitiveness in bids; etc.

In an effort to aid carriers in selecting loads that are suitable for them and to reduce the issues listed above, various loadboards in the marketplace use various techniques for matching carriers with loads that satisfy the carriers' search criteria. For example, one loadboard provides load recommendations based on carrier preferences, routes and equipment types; another loadboard provides load recommendations based on route optimization and efficiency; yet another loadboard uses equipment type, location and other preferences to recommend loads; yet another loadboard provides load recommendations based on capacity and preferences; yet another loadboard provides load recommendations based on historical interactions with the platform; and so on.

One common factor used by many loadboards to sort loads is rate per mile (RPM), which is the shipping rate offered for a particular run divided by the miles to complete that run. While RPM can be a useful indicator of the revenue a carrier can derive from the run, it fails to account for various other considerations such as dead head miles, break times, insurance and other administrative costs, etc. In cases where the mileage is low as in short-haul loads, RPM may be misleadingly high. In many cases, the carrier's search criteria (e.g., origin, destination, minimum RPM) can bring up so many disparate types of loads (e.g., short runs, long hauls, specialized equipment, etc.) that sorting through the search results can be time consuming, and sometimes inefficient, particularly where the results are not highly relevant to the carrier.

More often than not, carriers spend a lot of time manually clicking into loads from the load-search results on loadboards to evaluate and compare the profitability of the loads as applicable to them. For example, some loads returned in the search query may have a high RPM posted, but the mileage may be short (e.g., local hauls), which may not be of interest to the particular carrier or is not practically of use for evaluating the load. Some other loads may look promising, but the deadhead mileage for the carrier may be undesirable (e.g., carrier may have to drive a long way with an empty truck to pick up the load). Some loads may have a longer than desired lead time, whereas others may not provide for sufficient time for the carrier to pick up the load based on the carrier's current location. Although filters may be used, the carriers may nevertheless still need to go through all the loads being displayed, considering all the factors mentioned. In some cases, the returned results may be in the thousands, making the manual sorting and analysis a time consuming, inefficient, and often times frustrating process for the carrier.

Accordingly, embodiments of the freight management platform described herein disclose profitability score as a metric for evaluating and sorting loads on the loadboard. The profitability score can be considered as an adjusted (e.g., upgraded) RPM that provides, in an example, an indication of income per hour (e.g., a profitability score of 50 representing income of $50 per hour); in another example, the profitability score may represent an approximation of the worth of a load to a carrier in a unit of time. Higher the profitability score, higher is the income potential; and vice versa, suggesting that loads with higher profitability scores are likely to be more profitable, and as a result, more likely to be viewed and/or selected by carriers. The profitability score provides a universal metric for different types of loads (e.g., long haul, short haul), equipment (e.g., flatbeds, specialized equipment, etc.) and costs (e.g., fixed costs), considering each carriers' deadhead miles and lead time (among other factors).

In various embodiments, the profitability score is calculated as the ratio of adjusted rate to total trip time, where the adjusted rate is the posted rate adjusted for fixed costs of equipment (e.g., the lowest rate (e.g., price) a carrier is willing to accept to carry a load irrespective of the miles). For example, it is common that a carrier with a refrigerated truck may routinely handle jobs that pay more than another carrier with just a flatbed truck. The flatbed truck carrier may be willing to accept the lower paying jobs because the flatbed is less expensive to operate than the refrigerated truck. In another example, carriers with small trucks may accept lower paying jobs than carriers with bigger trucks, for example because the load freights are smaller, or the cost of the equipment is lower. The adjusted rate thus accounts for such differences among carrier equipment, leading to a better estimate of revenue. The total trip time is calculated based on the load travel time (e.g., travel time based on miles posted by broker and travel speed including breaks and hours of service as calculated statistically from data in the freight management platform), dead head miles (e.g., miles traveled without any freight, for example, to reach the location where the truck would be loaded and the driving speeds based statistically on the data in the freight management platform), and lead time (e.g., time spent from start of a job at the carrier's facility, for example, to when the loaded truck is actually on the road at the shipper's facility).

In various embodiments, a method is disclosed, comprising: receiving, at a load recommendation system in the freight management platform, a search query entered on a user interface by a carrier for loads posted on a loadboard, the search query including filters for one or more attributes of the loads; retrieving loads posted on the loadboard that satisfy the search query; retrieving data previously logged in the freight management platform; determining a profitability score for each retrieved load based on the data; and displaying on the user interface, the retrieved loads matching the filters in the search query and arranged according to the profitability score. The data comprises information on the carrier and other carriers, brokers, and routes; the profitability score represents hourly income from the corresponding load for the carrier; and the profitability score of any one load varies among different carriers. In some cases, the profitability score may be hourly income scaled by a suitable factor selected based on particular needs.

In the following detailed description, various aspects of the illustrative implementations may be described using terms commonly employed by those skilled in the art to convey the substance of their work to others skilled in the art.

The term “connected” means a direct connection (which may be one or more of a communication, mechanical, and/or electrical connection) between the things that are connected, without any intermediary devices, while the term “coupled” means either a direct connection between the things that are connected, or an indirect connection through one or more passive or active intermediary devices.

The term “computing device” means a server, a desktop computer, a laptop computer, a smartphone, or any device with a microprocessor, such as a central processing unit (CPU), general processing unit (GPU), or other such electronic component capable of executing processes of a software algorithm (such as a software program, code, application, macro, etc.).

The term “cloud network” means a network of computing devices coupled together in a public, private, or hybrid communications network. Communication in the cloud network may use one or more wired, wireless, broadband, radio, and other kinds of communicative means. The Internet is an example of a cloud network.

As used herein, the term “application” can be inclusive of an executable file comprising instructions that can be understood and processed on a computing device such as a computer, and may further include library modules loaded during execution, object files, system files, hardware logic, software logic, or any other executable modules. Applications are generally configured to perform particular tasks, or functions according to the type of application.

The description uses the phrases “in an embodiment” or “in embodiments,” which may each refer to one or more of the same or different embodiments.

Although certain elements may be referred to in the singular herein, such elements may include multiple sub-elements. For example, “a computing device” may include one or more computing devices.

Unless otherwise specified, the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

In the following detailed description, reference is made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

The accompanying drawings are not necessarily drawn to scale. In the drawings, same reference numerals refer to the same or analogous elements shown so that, unless stated otherwise, explanations of an element with a given reference numeral provided in context of one of the drawings are applicable to other drawings where element with the same reference numerals may be illustrated. Further, the singular and plural forms of the labels may be used with reference numerals to denote a single one and multiple ones respectively of the same or analogous type, species, or class of element.

Note that in the figures, various components are shown as aligned, adjacent, or physically proximate merely for ease of illustration; in actuality, some or all of them may be spatially distant from each other. In addition, there may be other components, such as routers, switches, antennas, communication devices, etc. in the networks disclosed that are not shown in the figures to prevent cluttering. Systems and networks described herein may include, in addition to the elements described, other components and services, including network management and access software, connectivity services, routing services, firewall services, load balancing services, content delivery networks, virtual private networks, etc. Further, the figures are intended to show relative arrangements of the components within their systems, and, in general, such systems may include other components that are not illustrated (e.g., various electronic components related to communications functionality, electrical connectivity, etc.).

In the drawings, a particular number and arrangement of structures and components are presented for illustrative purposes and any desired number or arrangement of such structures and components may be present in various embodiments. Further, unless otherwise specified, the structures shown in the figures may take any suitable form or shape according to various design considerations, manufacturing processes, and other criteria beyond the scope of the present disclosure.

For convenience, if a collection of drawings designated with different letters are present (e.g., FIGS. 11A-11G), such a collection may be referred to herein without the letters (e.g., as “FIG. 11”). Similarly, if a collection of reference numerals designated with different letters are present (e.g., 106a, 106b), such a collection may be referred to herein without the letters (e.g., as “106”) and individual ones in the collection may be referred to herein with the letters. Further, labels in upper case in the figures (e.g., 106A) may be written using lower case in the description herein (e.g., 106a) and should be construed as referring to the same elements.

Various operations may be described as multiple discrete actions or operations in turn in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

### Example Embodiments

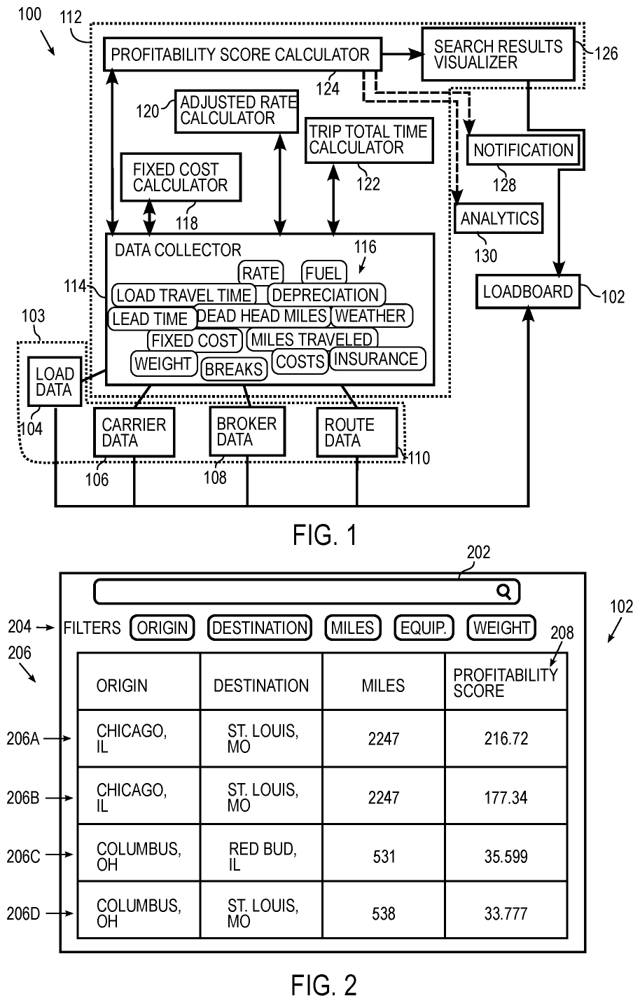

FIG. 1 is a simplified block diagram illustrating an example freight management platform 100 for load recommendation using profitability scores, according to some embodiments of the present disclosure. Freight management platform 100 may include a loadboard 102. Carriers and brokers (which can include shippers, logistics companies, and any others who post loads in freight management platform 100) may register on freight management platform 100. Note that the carrier may be a person, or a company. Where the latter, the term carrier as used herein includes a human user who acts in representative capacity for the carrier. Registration may involve providing details about the type of freight they handle (for carriers) or the type of shipments they need (for brokers). Other information can include home office location, fleet size, equipment types, etc. Carriers may also post their available trucks and equipment, specifying their capacity, routes, and other relevant information. Brokers may post details about available loads, including the type of cargo, weight, pick up and delivery locations, and any special requirements for the loads. Information about routes may be pulled from third-party databases, such as map services. Such postings and/or information may be entered on loadboard 102 suitably.

Carriers may search loadboard 102 for available loads that match their equipment, routes, and preferences. Brokers may search loadboard 102 for carriers that meet their shipping requirements. Once a potential match is found, carriers and brokers may communicate through freight management platform 100. They may negotiate rates, discuss delivery schedules, and address any specific requirements. When both parties agree on the terms, they may finalize the booking through loadboard 102. This often involves confirming the details, such as the pick up and delivery times, rates, and any other relevant information. Loadboard 102 may also provide tracking features that allow both brokers and carriers to monitor the progress of the shipment in real time. Updates on the load status, location, fuel used, and estimated time of arrival (among other information) may be logged into freight management platform 100 suitably. All such data 103 logged into loadboard 102 and/or other components of freight management platform 100 may be stored in load data 104, carrier data 106, broker data 108 and route data 110.

Carrier data 106 may include, as examples and not as limitations, carrier equipment, insurance, business metrics, preferences (e.g., route preferences, equipment preferences, etc.), historical data on past hauls, quality metrics, etc. of various carriers differentiated by carrier identifiers. Broker data 108 may include, as examples and not as limitations, broker's business metrics, business information, shippers and carriers engaged by the broker, historical data on past hauls posted, payment terms, terms of service, number of breaks allowed, hours of service permitted, complaints logged, etc. of various brokers differentiated by broker identifiers. In some embodiments, at least a portion of broker data 108 (e.g., rates for loads, complaints logged, etc.) may be estimated for individual brokers based at least on the loads posted by the respective broker and business information of the respective broker. In other embodiments, another portion of broker data 110 (e.g., hours of service permitted, number of breaks allowed, etc.) may be estimated as an average across a plurality of brokers based at least on the loads posted by the plurality of brokers and business information of the plurality of brokers. Route data 110 may include, as examples and not as limitations, maps, mileage, break locations, stops, traffic conditions, weather conditions, etc. In some embodiments, at least a subset of route data 110 may comprise information from third-party maps about various routes. Load data 104, carrier data 106, broker data 108 and route data 110 may comprise structured or unstructured data, entered manually or collected automatically from various sources (e.g., stops on a particular route gathered from data entered by numerous carriers; carrier's business information retrieved from external government filings; etc.).

A load recommendation system 112 may execute in freight management platform 100. Load recommendation system 112 may comprise a self-contained, modular unit of functionality within freight management platform 100 in some embodiments. Load recommendation system 112 may be developed, deployed and scaled independently of other components of freight management platform 100. In some embodiments, load recommendation system 112 may communicate with other parts of freight management platform 100 through suitable application programming interfaces (APIs). In some other embodiments, load recommendation system 112 may comprise a part of a larger monolithic application, for example, executing as a series of instructions within the larger framework by appropriate function calls with other similarly executing parts of the monolithic application. Load recommendation system 112 may thus execute in any suitable software architecture within the broad scope of the embodiments herein.

Load recommendation system 112 may include a data collector 114 that retrieves data 116, from a plurality of data sources (e.g., databases, data lakes, etc.) storing information relevant to carriers, brokers and routes (among others), including load data 104, carrier data 106, broker data 108 and route data 110. In various embodiments, data 116 gathered by data collector 114 may include as examples and not as limitations, rates, amount of fuel used in a trip, load travel time, lead time, dead head miles, fixed cost, miles traveled, weight, weather, insurance costs, administrative costs, number of breaks allowed, hours of service permitted, terms of service associated with brokers, etc. In some embodiments, portions of data 116 may be collected from load data 104, carrier data 106, broker data 108 and route data 110 and other portions collected from various calculators, such as fixed cost calculator 118, adjusted rate calculator 120, trip total time calculator 122, and profitability score calculator 124. Results from profitability score calculator 124 may be used by a search results visualizer 126 to display the results of a search query on loadboard 102 suitably.

In some embodiments, results from profitability score calculator 124 may be sent as notification 128, for example, as an in-app message, email, text message, etc. Notification 128 may be sent via the web (e.g., email or displayed in a web browser, etc.) or to a mobile device (e.g., text message, in-app message, etc.). In some other embodiments, results from profitability score calculator 124 may be sent to analytics 130, comprising for example, load optimization planners, business intelligence analysis, churn models, lead prioritization, etc. Any appropriate analytics may be performed using the profitability score within the broad scope of the embodiments. For example, the profitability score may be used to decide which loads are suitable to be undertaken sequentially by a carrier (e.g., load from destination A to B, then from B to C, then from C to D, and so on, each such trip selected according to the corresponding profitability scores). In another example, the profitability score can be used to estimate whether the carrier's business health, whether a broker is posting loads that are appropriate for the carriers signed into freight management platform 100, etc. In yet another example, the profitability scores can be used to predict churn by one or more carriers. In yet another example, the profitability score can be used in lead analytics, to predict whether a particular lead will turn into a paying customer.

Data collector 114 may periodically, or at certain preconfigured events, such as when data is updated in freight management platform 100, feed data 116 retrieved from load data 104, carrier data 106, broker data 108, and route data 110 to fixed cost calculator 118. Fixed cost calculator 118 may generate a regression model of rate and mileage for different equipment types. In an example, a best fit linear regression model may be used to capture the relationship between rate and mileage for a particular equipment type (e.g., flatbed truck). Other models may be generated for other equipment types. The fixed cost may be determined as the rate at zero mileage in the regression model. In other words, in a chart of mileage on the x-axis and rate on the y-axis, the y-intercept interpolated from the linear regression model is the fixed cost. The fixed cost may represent the lowest rate irrespective of miles accepted by the carrier and/or other carriers having the equipment type (e.g., the rate the carrier is willing to take a load using the equipment type with zero mileage, considering the costs for searching, negotiating, confirming, picking up and dropping off the load immediately).

The fixed cost is a hypothetical value not realized in real-life transactions on loadboard 102, but which represents a threshold rate for loads that the carrier would be interested in for that particular equipment type. The fixed cost may vary with different equipment types. For example, the fixed cost associated with specialized equipment such as refrigerated trucks, may be greater than another fixed cost associated with regular flatbed trucks. In various embodiments, a table associating equipment type with corresponding fixed cost may be stored in freight management platform 100 and updated as needed.

During operation, a carrier may enter a search query in loadboard 102, or log into freight management platform 100, which in turn triggers the search query, for example, based on the carrier's profile, preferences, use history, etc. According to various embodiments, load recommendation system 112 may be instantiated upon receiving the search query in freight management platform 100. Load recommendation system 112 may use data 116 to calculate a profitability score for each load returned by the search query and display the results in loadboard 102 arranged according to the profitability score. In various embodiments, the profitability score for each load returned by the search query may be based on data 103, and at least a part of the determining may be based on a subset of data 103 relevant to the search query.

In an example, consider a carrier based in St. Lous, MO, and currently (i.e., at the time of running a search on loadboard 102) located in Chicago, IL. The carrier may be interested in returning home to St. Louis, MO. The carrier may also be interested in loads to an intermediate town between Chicago, IL and St. Louis, MO. The carrier may have certain equipment, such as a heavy-duty flatbed truck with a payload capacity greater than 20,000 lbs. The carrier's business may have a fleet of similar trucks with certain running costs higher than an independent trucker-operator. Such information may be previously logged into freight management platform 100 and included in carrier data 106.

According to embodiments of freight management platform 100 as described herein, when the carrier runs a search on loadboard 102 for loads of interest, the search query specifying at least origin, destination, mileage, information relevant to the equipment type (e.g., weight, refrigerated goods, wide loads, etc.), and other filters of interest, adjusted rate calculator 120 may identify the equipment type indicated by the search query and retrieve the fixed cost for the equipment type, the fixed cost having been previously calculated by fixed cost calculator 118. In another scenario, when a user logs into freight management platform 100 with access credentials associated with a carrier, the user's preference, the carrier details, the carrier's (or the user's) use history and such data stored in freight management platform 100 may be used to estimate (e.g., formulate, create, predict, assess, determine) a suitable search query, which may be run in the background to return relevant loads. Thereafter, for each load returned by the search query, adjusted rate calculator 120 may calculate an adjusted rate by subtracting the fixed cost for the equipment type from the posted rate for the load.

In response to the search query, trip total time calculator 122 may also be instantiated. A determination may be made whether data 116 retrieved from load data 104, carrier data 106, broker data 108 and route data 110 and stored in a temporary cache is relevant to further calculations. Examples of data relevant to the search query may include information on brokers who have posted the loads, routes previously traversed by other carriers between the origins and destinations of the loads retrieved by the search query, break times and hours of service posted by brokers for such routes, other carriers who completed loads for the brokers or along the routes, etc. Data not relevant to the loads may not be collected or else if previously collected, then deleted from the temporary cache or ignored in further calculations. Whether data is relevant to the load may be preconfigured according to appropriate decision trees based on heuristic rules in some embodiments. In other embodiments, the relevancy may be determined by machine learning models that generate decision trees based on historical data logged into freight management platform 100. In yet other embodiments, a combination of heuristic rules and machine learning models may be used to generate the decision trees. In yet other embodiments, instead of decision trees, other decision metrics may be used.

For each load returned by the search query, trip total time calculator 122 may generate a regression model of estimated speed to travel mileage (e.g., posted miles) based on data 116 retrieved from load data 104, carrier data 106, broker data 108 and route data 110 relevant to the load. The estimated speed is not the actual speed of the carrier, but rather, a ratio of the posted miles to the time between pickup and drop off for a particular load logged previously in freight management platform 100. The estimated speed may account for hours of service, break times, traffic, road conditions, and other factors that are typically not logged expressly in freight management platform 100, but which can be gathered from the time taken between pickup and drop off for the particular load. Such travel speed may vary depending on the broker, or the route, or the carrier, or a combination thereof. The regression model of the estimated speed to travel mileage may thus vary accordingly based on the data used to generate the regression model. In some embodiments, the regression model may include hours of service obtained from government regulations where corresponding broker data is not available. In some embodiments, the regression model may be a linear fit between the estimated speed and the travel mileage. For the load under consideration, trip total time calculator 122 may compute a load travel time as a ratio of the posted travel mileage for the load to the calculated travel speed. The load travel time thus calculated may provide a more accurate representation of the expected speed by the carrier for the load. The greater the load travel time, lower may be the expected income per hour from the load.

For each load, trip total time calculator 122 may compute the dead head miles for the carrier based on a relative location of the carrier to an origin location of the load (i.e., load origin). The term “dead head miles” refers to the distance (e.g., mileage) traveled by the carrier from the current or starting location to the pickup origin or from the drop-off location to the ending location with an empty truck. In most cases, the carrier must traverse some dead head miles to pick up the load from the load origin. For example, the load may have to be picked up from a warehouse distant from where the carrier's empty equipment is parked. The longer the dead miles traversed, the greater is the cost (i.e., lower the income) for the carrier.

For each load, trip total time calculator 122 may also generate another regression model of estimated speed to dead head mileage based on data 116 retrieved from load data 104, carrier data 106, broker data 108 and route data 110 relevant to the load. The estimated speed is not the actual speed of the carrier, but rather, a scaled version of the travel speed based on government regulations. In a simplified example, government regulations may stipulate that truck drivers must be off the road after 11 hours of driving in a 24 hour window; the estimated speed in such cases is the travel speed multiplied by a ratio of 24 to 11. For the load under consideration, trip total time calculator 122 may compute a dead head miles driving time as a ratio of the dead head miles for the load to the calculated driving speed. The dead head miles driving time represents lost income for the carrier; greater the dead head miles driving time, greater is the loss.

For each load, trip total time calculator 122 may also compute a lead time. The lead time may be gathered from historical data about the broker, carrier, route, or the load origin previously logged in freight management platform 100 and retrieved in load data 104, carrier data 106, broker data 108 and route data 110 relevant to the load. The lead time represents the time taken to load the equipment at the load origin. Lead time includes order processing time and the time a carrier needs to spend before they can pickup a load. For example, if a carrier prefers a load leaving immediately but rather found a load leaving tomorrow, they will be waiting 24 hours with no income. The greater the lead time, lower is the income per hour for the carrier. Note that the load travel time, dead head miles driving time and the lead time may all be calculated concurrently or serially, based on job scheduler settings in freight management platform 100.

Thereafter, trip total time calculator 122 may calculate a trip total time for the load as a sum of the load travel time, dead head miles driving time and the lead time for each load. Subsequently, for each load, profitability score calculator 124 may calculate the profitability score as a ratio of the adjusted rate as calculated by adjusted rate calculator 120 and the trip total time as calculated by trip total time calculator 122. Note that the calculation of each variable encompassed by the profitability score may include diverse data 103 in freight management platform 100, for example, fuel, weight, weather, equipment depreciation, insurance costs, and administrative costs. Each load returned by the search query may be filtered and arranged according to the computed profitability score by search results visualizer 126, with the highest profitability score being at the top of the list, and the lowest profitability score being at the bottom in some embodiments.

Note that the profitability score may vary depending on the carrier entering the search query or carrier's preference and use history on freight management platform 100. For example, the dead head driving miles for a carrier located 2 miles from the origin location of a posted load may be different from the dead head driving miles for a carrier located 200 miles from the origin location of the posted load. Likewise, a load that can be carried by more than one equipment type may reflect different profitability scores depending on the equipment type selected. Thus, a carrier with one of the equipment types may see one profitability score for the posted load, whereas a carrier with another of the equipment types may see another profitability score for the same posted load. In yet another example, a carrier may be available earlier than another carrier, leading to longer lead times for that carrier, which impacts the profitability score accordingly.

Consider, for example, the search query previously discussed, for loads exceeding 20,000 lbs originating in Chicago, IL. Assume the filters include a pickup date range (e.g., February 27-28), equipment (e.g., flatbed), weight, and distance. Assume, merely for example purposes and not as a limitation, that one of the loads returned in the search query is for a load from Chicago, IL, to Pueblo, CO, covering 1,120 miles at a posted rate of $3,200. The fixed cost for the flatbed truck as estimated from previously logged data in freight management platform 100 may be $191.25 (as an example only and not as a limitation). The adjusted rate for the load is $3,200-$191.25=$3,008.75. Assume, merely as an example and not as a limitation, that the regression model for the travel speed as applied to the load is 16.41+0.005*mileage=22.01; the dead head miles is 118 miles; the regression model for the dead head miles driving speed as applied to the load is 35.80+0.012*dead head mileage=37.2; and the lead time is 12. The profitability score for the load is thus $45.569, representing the income per hour for the carrier to complete the load. Profitability scores for other loads returned in the search query may also be calculated and displayed appropriately in loadboard 102. In this example, the regression models for fixed cost, travel speed, and driving speed are linear models; however, any suitable regression model may be used within the broad scope of the embodiments. In some embodiments, machine learning models may be used to generate regression models based on particular needs.

FIG. 2 is a simplified diagram illustrating an example user interface for loadboard 102, according to embodiments of the present disclosure. A search bar 202 may allow for search terms to be entered suitably. In some embodiments, instead of, or in addition to search bar 202, filters 204 may be provided to enable users to filter for specific criteria. In the example shown, filters 204 for origin, destination, miles, equipment type and weight may be included in the search query. Results of the search query may be displayed as a table in some embodiments. In the example shown, loads 206 (e.g., 206a, 206b, 206c, 206d) are listed in separate rows. A profitability score 208 may be calculated for each load 206a . . . 206d returned by the search query and loads 206 may be arranged according to profitability score 208, for example, with the highest profitability score at the top. Various other configurations and display options are possible within the broad scope of the embodiments herein.

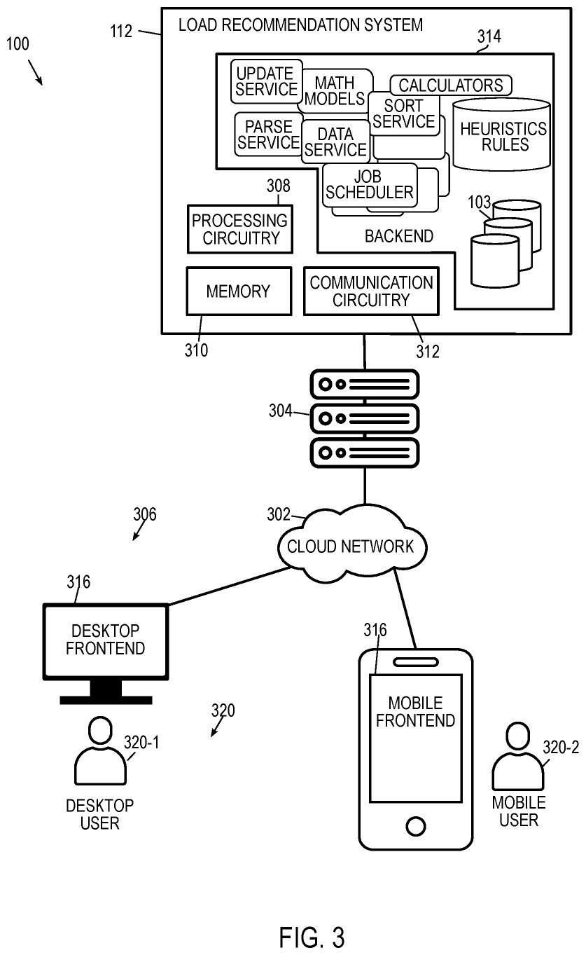

FIG. 3 is a simplified block diagram illustrating other example details of freight management platform 100, according to some embodiments of the present disclosure. In example implementations, at least some portions of the activities outlined herein may be hosted on a cloud network 302 in one or more servers 304. At least some other portions of the activities outlined herein may be implemented in one or more computing devices 306 connected over one or more communication networks with cloud network 302. In particular embodiments, cloud network 302 is a collection of hardware devices and executable software forming a shared pool of configurable computing resources (e.g., networks, servers, storage, applications, services, etc.) that may be suitably provisioned to provide on-demand self-service, network access, resource pooling, elasticity and measured service, among other features. Computing device 306 may have any desired form factor, such as a handheld or mobile computing device (e.g., a cell phone, a smart phone, a mobile Internet device, a tablet computer, a laptop computer, a netbook computer, an ultra-book computer, a Personal Digital Assistant (PDA), an ultramobile personal computer, etc.), a desktop computing device, a server or other networked computing component, a set-top box, an entertainment control unit, or a wearable computing device.

Certain portions of freight management platform 100 may execute using a processing circuitry 308, a memory 310 and communication circuitry 312 (among other components) in one or more servers 304. Certain other portions of freight management platform 100 may execute in one or more computing devices 306 using respective processing circuitry, memory, and communication circuitry (not shown with particularity so as not to clutter the drawing) substantially similar in functionalities to processing circuitry 308, memory 310 and communication circuitry 312. In some embodiments, one or more of these features may be implemented in hardware, provided external to these elements, or consolidated in any appropriate manner to achieve the intended functionality. The various network elements in freight management platform 100 may include communication software that can coordinate to achieve the operations as outlined herein. In still other embodiments, these elements may include any suitable algorithms, hardware, software, components, modules, interfaces, or objects that facilitate the operations thereof.

Processing circuitry 308 may execute any type of instructions associated with data stored in memory 310 to achieve the operations detailed herein. In one example, processing circuitry 308 may transform data from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., field programmable gate array (FPGA), an erasable programmable read only memory (EPROM), an application specific integrated circuit (ASIC)) that includes digital logic, software, code, electronic instructions, flash memory, optical disks, magnetic or optical cards, other types of machine-readable mediums suitable for storing electronic instructions, or any suitable combination thereof.

In some of example embodiments, one or more memory 310 may store data used for the operations described herein. This includes memory 310 storing instructions (e.g., software, logic, code, etc.) in non-transitory media (e.g., random access memory (RAM), read only memory (ROM), FPGA, EPROM, etc.) such that the instructions are executed to carry out the activities described in this disclosure based on particular needs. In some embodiments, memory 310 may comprise non-transitory computer-readable media, including one or more memory devices such as volatile memory such as dynamic RAM (DRAM), nonvolatile memory (e.g., ROM), flash memory, solid-state memory, and/or a hard drive. In some embodiments, memory 310 may share a die with processing circuitry 308. Memory 310 may include algorithms, code, software modules, and applications, which may be executed by processing circuitry 308. The data being tracked, sent, received, or stored in freight management platform 100 may be provided in any database, register, table, cache, queue, control list, or storage structure, based on particular needs and implementations, all of which could be referenced in any suitable timeframe.

Communication circuitry 312 may be configured for managing wired or wireless communications for the transfer of data in freight management platform 100. The term “wireless” and its derivatives may be used to describe circuits, devices, systems, methods, techniques, communications channels, etc., that may communicate data through modulated electromagnetic radiation in a nonsolid medium. The term does not imply that the associated devices do not contain any wires, although in some embodiments they might not. Communication circuitry 312 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long Term Evolution (LTE) project along with any amendments, updates, and/or revisions (e.g., advanced LTE project, ultramobile broadband (UMB) project (also referred to as “3GPP2”), etc.). Communication circuitry 312 may operate in accordance with a Global System for Mobile Communication (GSM), General Packet Radio Service (GPRS), Universal Mobile Telecommunications System (UMTS), High-Speed Packet Access (HSPA), Evolved HSPA (E-HSPA), or LTE network. Communication circuitry 312 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). Communication circuitry 312 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. Communication circuitry 312 may operate in accordance with other wireless protocols in other embodiments. Communication circuitry 312 may include antennas to facilitate wireless communications and/or to receive other wireless communications.

In some embodiments, communication circuitry 312 may manage wired communications, such as electrical, optical, or any other suitable communication protocols (e.g., the Ethernet, Internet). Communication circuitry 312 may include multiple communication chips. For instance, a first communication chip may be dedicated to shorter-range wireless communications such as Wi-Fi or Bluetooth, and a second communication chip may be dedicated to longer-range wireless communications such as global positioning system (GPS), EDGE, GPRS, CDMA, WiMAX, LTE, EV-DO, or others. In some embodiments, a first communication chip may be dedicated to wireless communications, and a second communication chip may be dedicated to wired communications.

The example network environment may be configured over a physical infrastructure that may include one or more networks and, further, may be configured in any form including, but not limited to, local area networks (LANs), wireless local area networks (WLANs), virtual local area networks (VLANs), metropolitan area networks (MANs), wide area networks (WANs), virtual private networks (VPNs), Intranet, Extranet, any other appropriate architecture or system, or any combination thereof that facilitates communications in a network. In some embodiments, a communication link may represent any electronic link supporting a LAN environment such as, for example, cable, Ethernet, wireless technologies (e.g., IEEE 802.11x), ATM, fiber optics, etc. or any suitable combination thereof. In other embodiments, communication links may represent a remote connection through any appropriate medium (e.g., digital subscriber lines (DSL), telephone lines, T1 lines, T3 lines, wireless, satellite, fiber optics, cable, Ethernet, etc. or any combination thereof) and/or through any additional networks such as a WANs (e.g., the Internet).

In various embodiments, freight management platform 100 may be partitioned into a backend 314 and a frontend 316. Backend 314 may comprise various components of load recommendation system 112, such as services (e.g., update service, calculators, parse service, data service, math models, sort service, job scheduler, heuristic rules, data 103, etc.). Likewise, frontend 316 may comprise web interface or application interface provisioned in one or more computing devices 306. Backend 314 may comprise various modules, logic, software engines and other components that are distributed (and common) across all users of freight management platform 100. Backend 314 may execute operations for managing and processing data, performing computations, and facilitating communication between different components, such as components of load recommendation system 112. In particular embodiments, backend 314 may include operations such as data management, business logic, user authentication and authorization, security and validation, application programming interfaces (APIs) with third-party components such as payment processors, etc. In some embodiments (as shown), data 103 may be provisioned as a part of load recommendation system 112; in other embodiments, data 103 may be provisioned in separate servers distant from load recommendation system 112.

In a general sense, frontend 316 comprises a user interface using which users 320 (e.g., 320-1, 320-2) interact with freight management platform 100. In an example embodiment, loadboard 102 may be displayed by frontend 316. Frontend 316 may also include libraries, forms, device integrators and other components as desired and based on particular needs. Frontend 316 may be presented on a suitable display device coupled to computing device 306 and appropriate to show visual indicators, such as a heads-up display, a computer monitor, a projector, a touchscreen display, a liquid crystal display (LCD), a light-emitting diode display, and/or a flat panel display. In various embodiments, frontend 316 may be specific to the particular access credentials of the user accessing freight management platform 100. For example, carriers may be presented with one frontend 316; brokers may be presented with another frontend 316; and logistics companies may be provided with yet another frontend 316. In some embodiments, frontend 316 may conform to the device; for example, desktops may have one frontend 316 and mobile devices may have another frontend 316. In various embodiments, frontend 316 may be a web browser in which loadboard 102 executes. In other embodiments, frontend 316 may comprise a standalone application in which loadboard 102 executes.

Freight management platform 100 described and shown herein (and/or its associated structures) may also include suitable interfaces for receiving, transmitting, and/or otherwise communicating data or information in a network environment. In a general sense, the arrangements depicted in the figures may be more logical in their representations, whereas a physical architecture may include various permutations, combinations, and/or hybrids of these elements. It is imperative to note that countless possible design configurations can be used to achieve the operational objectives outlined here. Accordingly, the associated infrastructure has a myriad of substitute arrangements, design choices, device possibilities, hardware configurations, software implementations, equipment options, etc.

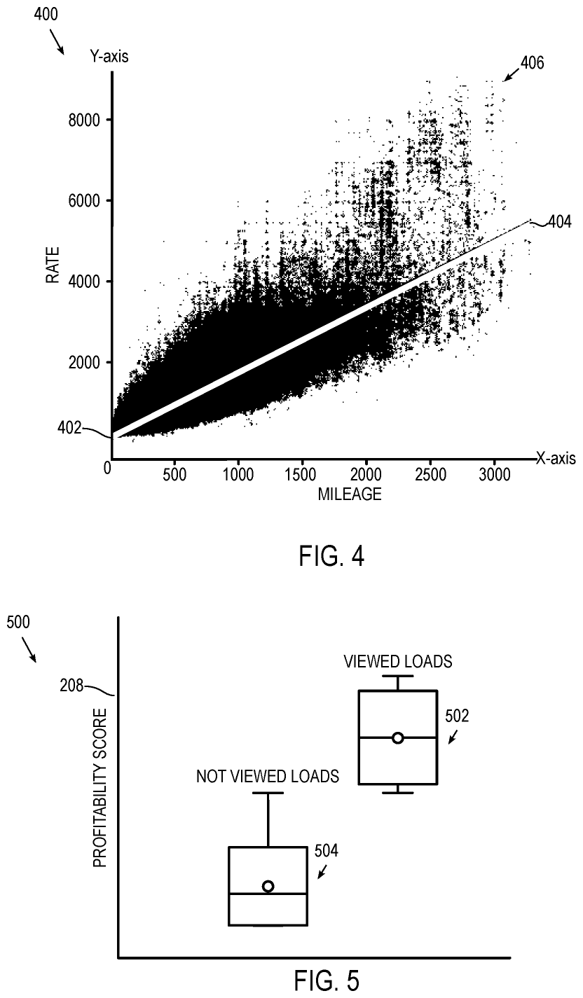

FIG. 4 is a simplified block diagram illustrating an example chart 400 for estimating a fixed cost 402 in freight management platform 100, according to some embodiments of the present disclosure. Chart 400 shown here is merely for example purposes; fixed cost calculator 118 may not plot the chart per se, but rather generate a regression model 404 and estimate fixed cost 402 therefrom. Chart 400 includes a plot of data points 406 of rate (e.g., posted rate or booked rate) on the y-axis and mileage on the x-axis. Each data point 406 represents a load previously logged in freight management platform 100 for a particular equipment type. As can be seen from chart 400, as the mileage increases, the rate is also generally higher. There can be variation among the different loads posted for the same mileage depending on the broker that is posting the load, business considerations, route conditions, load types, etc. Regression model 404 may represent a best fit for data points 406. In some embodiments, regression model 404 may be generated using a least squares method. In some other embodiments, one or more machine learning model may be used to generate regression model 404. Examples of machine learning models for generating regression model 404 include support vector regression model, neural networks, gradient boosting algorithms, etc. As discussed previously, fixed cost 402 is the y-intercept of regression model 404, at a mileage of 0, representing a threshold (e.g., floor) rate for that equipment type.

FIG. 5 is a simplified chart illustrating an example chart 500 showing loads with profitability score 208 categorized suitably according to some embodiments of the present disclosure. Loads 502 represent viewed loads, and loads 504 represent not viewed loads in loadboard 102. In other words, loads 502 are those that a user has clicked on loadboard 102 and viewed in more detail; loads 504 are those that a user has ignored in loadboard 102. As shown in chart 500, viewed loads 502 have higher profitability score 208 that not viewed loads 504, indicating that loads with higher profitability scores have a higher likelihood of being viewed in loadboard 102.

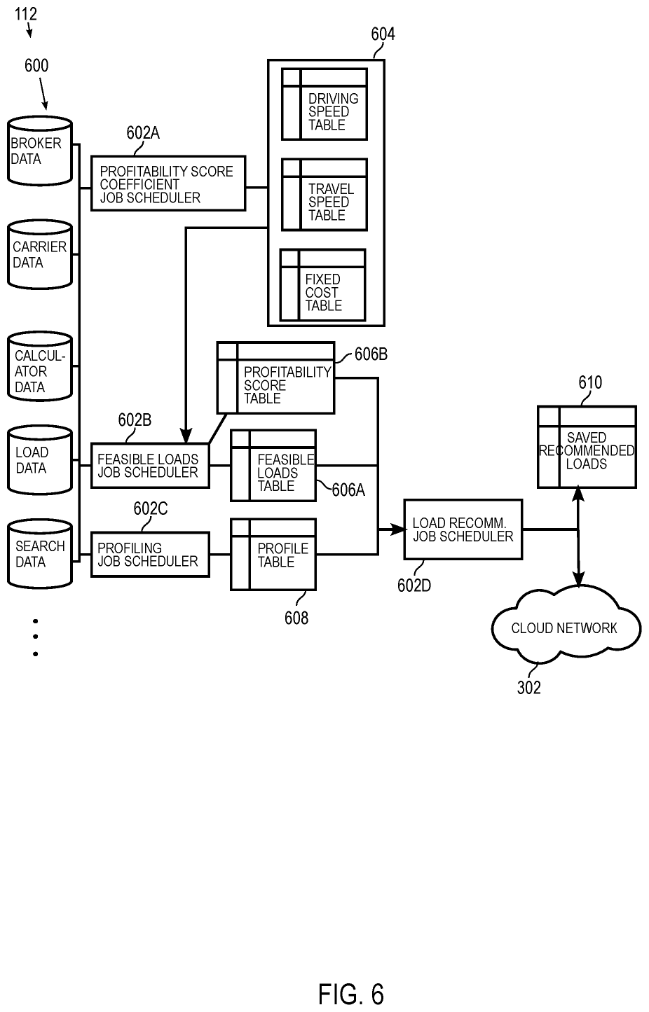

FIG. 6 is a simplified block diagram showing an example scheduling structure for load recommendation system 112 according to embodiments of the present disclosure. In some embodiments, profitability score 208 may be calculated in real time as loads are returned by the search query. In some other embodiments, as shown herein, at least some portion of the calculations relevant to computing profitability score 208 may be calculated apriori and stored appropriately according to a predetermined schedule. In some such embodiments, load recommendation system 112 may include a plurality of microservices 600 coordinated by a plurality of job schedulers 602, such as profitability score coefficient job scheduler 602a, feasible loads job scheduler 602b, profiling job scheduler 602c and load recommendation job scheduler 602d. In various embodiments, job schedulers 602 may comprise time based cronjobs. Plurality of microservices 600 may perform various actions, such as retrieving data, storing data, calculating, etc. Plurality of microservices 600 may communicate with each other over respective APIs. Job schedulers 602 may coordinate the plurality of microservices suitably.

Each job scheduler 602 may schedule various scripts to run (e.g., corresponding to plurality of microservices 600) to generate respective data, for example, coefficients of regression models formatted as tables. In an example embodiment, as shown, profitability score coefficient job scheduler 602 may run scripts to calculate regression model coefficients, load travel time, dead head miles driving time, lead time, fixed cost, etc., which may be stored as tables 604 for each load returned by the search query. In some embodiments, some regression model data may be generated by some scripts before other regression model data are generated by other scripts and profitability score coefficient job scheduler 602a may schedule such scripts accordingly. Any suitable sequence of executing of scripts may be scheduled by profitability score coefficient job scheduler 602a based on particular needs.

Likewise, feasible loads job scheduler 602b may schedule various scripts to run to generate tables 606, comprising the loads and corresponding profitability scores returned by the search query according to the one or more filters chosen by the user. In some embodiments, feasible loads job scheduler 602b may run a script to compute profitability score 208 using data in tables 604 and store the returned feasible loads in table 606a and profitability scores in table 606b. Similarly, profiling job scheduler 602c may schedule various scripts to run to generate profile table 608 for the particular carrier performing the search. Load recommendation job scheduler 602d may schedule various scripts to run that consumer the data thus generated to generate recommended loads, which may be saved as a table 610. The results may thereafter be communicated over cloud network 302 to appropriate frontend 316 running in the user's computing device 306.

Although the present disclosure has been described in detail with reference to particular arrangements and configurations, these example configurations and arrangements may be changed significantly without departing from the scope of the present disclosure. For example, although the present disclosure has been described with reference to particular network systems such as cloud networks, freight management platform 100 may be implemented in other networks such as LANs. Moreover, although freight management platform 100 has been illustrated with reference to particular elements and operations that facilitate the software process, these elements, and operations may be replaced by any suitable architecture or process that achieves the intended functionality of freight management platform 100.

### Example Methods

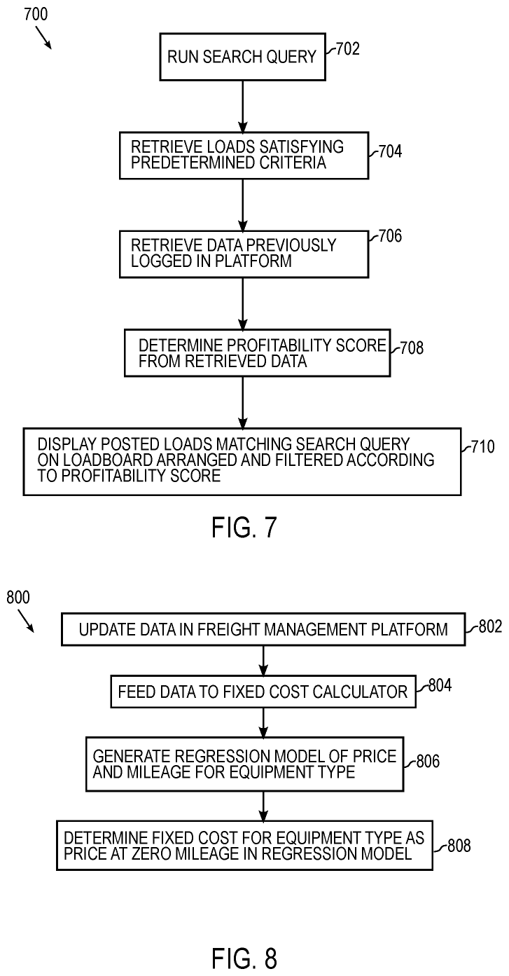

FIG. 7 is a simplified flow diagram illustrating example operations 700 associated with the freight management platform 100, according to some embodiments of the present disclosure. At 702, loadboard 102 may run a search query. In some cases, the search query may be manually entered by a carrier (i.e., human user representing a carrier). In some other cases, the search query may be run automatically when the user logs into freight management platform 100 using access credentials associated with a carrier. In some such cases, the search query may be formulated based on user preferences, user profile, and/or user history stored in freight management platform 100. At 704, loadboard 102 may retrieve loads 206 satisfying certain predetermined criteria, such as the search query, user profile, or inferred user preferences. At 706, load recommendation system 112 may retrieve data 116 previously logged in freight management platform 100. At 708, load recommendation system 112 may determined profitability score 208 for each load 206 from retrieved data 116. At 710, load recommendation system 112 may display posted loads 206 matching the search query on loadboard 102, arranged and filtered according to the profitability score determined at 708. In some embodiments, loads with profitability score 208 lower than a predetermined threshold may not be displayed on loadboard 102. In other embodiments, only loads having profitability score 208 higher than a predetermined threshold may be displayed.

FIG. 8 is a simplified flow diagram illustrating example operations 800 associated with the freight management platform 100, according to some embodiments of the present disclosure. At 802, data in freight management platform 100 may be updated, for example, when a new load is posted by a broker, or when a carrier updates information, or when a new user registers, etc. Any suitable mechanism that changes data 103 stored in freight management platform 100 may be included in 802. At 804, data 103 in freight management platform may be fed (e.g., pushed) to fixed cost calculator 118. In some embodiments, fixed cost calculator 118 may pull data 103 suitably. Any mechanism to provide data 103 to fixed cost calculator 118 is included in 804. At 806, fixed cost calculator 118 may generate regression model 404 of rate and mileage for a particular equipment type. Operations 806 and 808 may be repeated for different equipment types in freight management platform 100. In some embodiments, the fixed cost for each equipment type may be stored as a table suitably in freight management platform 100.

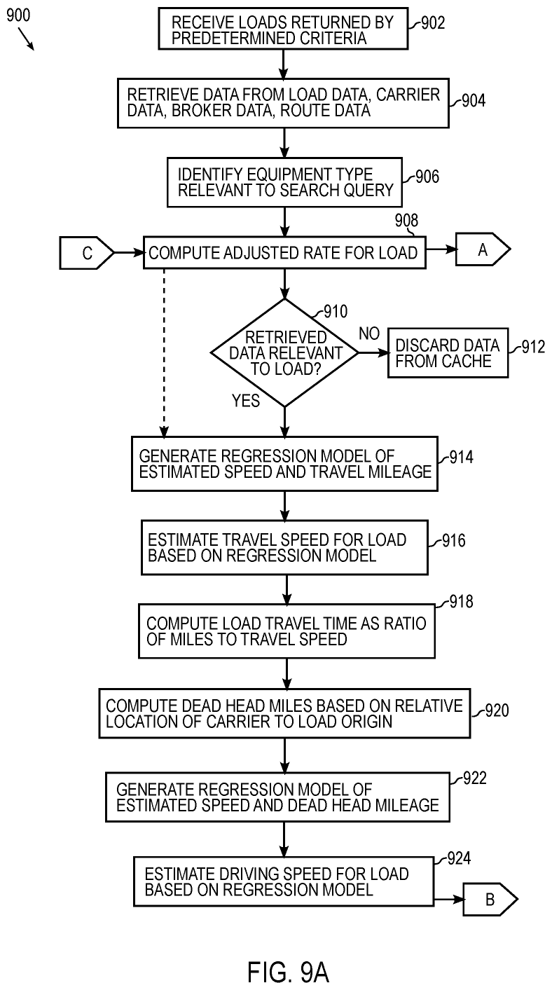

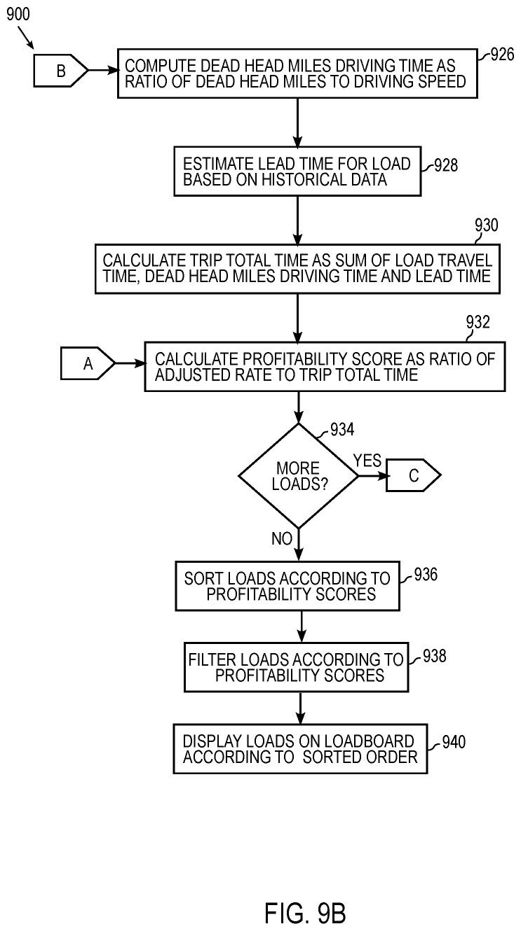

FIGS. 9A-9B is a simplified flow diagram illustrating example operations 900 associated with freight management platform 100, according to some embodiments of the present disclosure. At 902 in FIG. 9A, load recommendation system 112 may receive loads 206 returned by certain predetermined criteria, such as search query, user profile and/or inferred user preferences. In various embodiments, a carrier may enter the search query in loadboard 102, thereby instantiating load recommendation system 112, which may receive loads 206. In another embodiment, a carrier may log into freight management platform 100, thereby triggering a search for loads based on the carrier's profile and/or inferred user preferences. Any other suitable criteria may be used within the broad scope of the embodiments.

At 904, data 116 may be retrieved from load data 104, carrier data 106, broker data 108 and route data 110 and stored appropriately in a temporary cache (e.g., in memory 310). At 906, the equipment type relevant to the search query may be identified. The identification may be performed by parsing the search query for search terms indicative of the equipment type in some embodiments. For example, the search query may provide for a tonnage restriction, which may be used to infer and identify the equipment type desired. In another embodiment, the equipment type may be identified from filters used in the search query. Various other mechanisms may be used to identify the equipment type relevant to the search query.

At 908, a first load in the list of loads returned by the search query may be selected and the adjusted rate for the load calculated by adjusted rate calculator 120 as the posted rate for the load subtracted by the fixed cost saved previously in freight management platform 100 for the equipment type identified at 906. At 910, a determination may be made whether retrieved data 116 is relevant to the selected load. In some embodiments, the relevancy of each piece of data 116 (e.g., broker name, posted origin of a load, carrier name, etc.) may be analyzed separately. In other embodiments, the relevancy of sets of data may be analyzed as a whole (e.g., all information pertaining to a particular broker may be determined to be relevant). Whether data is relevant to the load may be preconfigured according to appropriate decision trees based on heuristic rules in some embodiments. In other embodiments, the relevancy may be determined by machine learning models that generate decision trees based on historical data logged into freight management platform 100. If the data is not relevant, the data may be discarded from the temporary cache.

The operations may then step to 914, at which a regression model of estimated speed to travel mileage may be generated by trip total time calculator 122. In some embodiments, determining the relevancy of data 116 may be skipped and the operations may step from 908 directly to 914. The regression model of estimated speed to travel mileage (e.g., posted miles) may be based on data 116. The estimated speed is not the actual speed of the carrier, but rather, a ratio of the posted miles to the time taken between pickup and drop off for a particular load logged previously in freight management platform 100. The estimated speed may account for hours of service, break times, traffic, road conditions, and other factors that are typically not logged expressly in freight management platform 100, but which can be gathered from the time taken between pickup and drop off for the particular load. Such travel speed may vary depending on the broker, or the route, or the carrier, or a combination thereof. The regression model of the estimated speed to travel mileage may thus vary accordingly based on the data used to generate the regression model. In some embodiments, the regression model may be a linear fit between the estimated speed and the travel mileage.

At 916, for the load under consideration, trip total time calculator 122 may estimate the travel speed using the regression model generated at 914 for the posted miles of the load. At 918, trip total time calculator 122 may estimate a load travel time as a ratio of the posted travel mileage for the load to the calculated travel speed. The load travel time thus calculated may provide a more accurate representation of the expected speed by the carrier for the load. The greater the load travel time, lower may be the expected income per hour from the load.

At 920, trip total time calculator 122 may compute the dead head miles for the carrier based on a relative location of the carrier to an origin location of the load (i.e., load origin). At 922, trip total time calculator 122 may generate another regression model of estimated speed to dead head mileage based on data 116. The estimated speed is not the actual speed of the carrier, but rather, a ratio of the dead head miles to the time taken between drop off of a particular load by a carrier and pickup of the next load by the carrier as logged previously in freight management platform 100. At 924, for the load under consideration, trip total time calculator 122 may estimate the driving speed using the regression model generated at 922 for the dead head miles estimated at 920.

The operations may step to 926 in FIG. 9B. For the load under consideration, trip total time calculator 122 may compute a dead head miles driving time as a ratio of the dead head miles for the load to the calculated driving speed. The dead head miles driving time represents lost income for the carrier; greater the dead head miles driving time, greater is the loss. At 928, trip total time calculator 122 may also compute a lead time. The lead time may be gathered from historical data about the broker, or the load origin previously logged in freight management platform 100 and retrieved in data 116. The lead time represents the time taken to load the equipment at the load origin. The greater the lead time, lower is the income per hour for the carrier. Note that operations 914-918, 920-926 and 928 may be performed concurrently or sequentially within the broad scope of the embodiments.

At 930, trip total time calculator 122 may calculate a trip total time for the load as a sum of the load travel time calculated at 918, dead head miles driving time calculated at 926 and the lead time calculated at 928. At 932, profitability score calculator 124 may calculate profitability score 208 as a ratio of the adjusted rate calculated at 908 and the trip total time calculated at 930. At 934, a determination may be made whether additional loads are to be analyzed and profitability score calculated therefor. If yes, the operations return to 908 and continue thereafter.

If all loads returned by the search query have been assigned corresponding profitability score 208 as calculated at 932, the operations may proceed to 936, at which loads 206 may be sorted according to profitability score 208. At 938, the loads may be filtered according to profitability score 208. In some embodiments, loads having profitability score 208 less than a predetermined threshold may be filtered out. In other embodiments, loads having profitability score 208 more than a predetermined threshold may be retained, and the others filtered out. At 940, search results visualized 126 may display loads on loadboard 102 according to the sorted order and filtered suitable, for example, with the highest profitability score being at the top of the list, and the lowest profitability score being at the bottom and loads with profitability score lower than the predetermined threshold not displayed at all.

In various embodiments, the operations described in FIGS. 7-9 are performed automatically without human intervention. Although FIGS. 7-9 illustrate various operations performed in a particular order, this is simply illustrative, and the operations discussed herein may be reordered and/or repeated as suitable. Further, additional operations which are not illustrated may also be performed without departing from the scope of the present disclosure. Also, various ones of the operations discussed herein with respect to FIGS. 7-9 may be modified in accordance with the present disclosure to facilitate load recommendation system 112 in freight management platform 100 as disclosed herein. Although various operations are illustrated in FIGS. 7-9 once each, the operations may be repeated as often as desired.

It is important to note that the operations described with reference to the preceding figures illustrate only some of the possible scenarios that may be executed by, or within, freight management platform 100. Some of these operations may be deleted or removed where appropriate, or these steps may be modified or changed considerably without departing from the scope of the discussed concepts. In addition, the timing of these operations may be altered considerably and still achieve the results taught in this disclosure. The preceding operational flows have been offered for purposes of example and discussion.

Example 1 provides a method for load recommendation using profitability scores in a freight management platform, the method including receiving, at a load recommendation system in the freight management platform, a search query associated with a carrier for loads posted on a loadboard, the search query including at least one filter indicative of an equipment type; retrieving, by the load recommendation system, loads posted on the loadboard that satisfy the search query; retrieving, by the load recommendation system, data logged previously in the freight management platform; determining, by the load recommendation system, a profitability score for each retrieved load based on the data, at least a part of the determining based on a subset of the data relevant to the search query; and displaying, by the load recommendation system on a user interface, the retrieved loads matching the filters in the search query and arranged according to the profitability score, in which: the data includes information on loads, the carrier and other carriers, brokers, and routes, the profitability score represents hourly income for the carrier from the corresponding retrieved load, and the profitability score of any one load varies among different carriers.

### Select Examples

Example 2 provides the method of example 1, in which the data includes preferences, business information, equipment, and historical data of the carrier and other carriers previously logged in the freight management platform.

Example 3 provides the method of example 1 or 2, in which the data includes posted loads, number of breaks allowed, hours of service permitted, and terms of service associated with brokers as previously logged in the freight management platform.

Example 4 provides the method of example 3, in which the data is estimated for individual brokers based at least on loads posted by the respective broker and business information of the respective broker.

Example 5 provides the method of example 3 or 4, in which the data is estimated as an average across a plurality of brokers based at least on the loads posted by the plurality of brokers and business information of the plurality of brokers.

Example 6 provides the method of any one of examples 1-5, in which the data includes information about routes previously logged by carriers in the freight management platform and information from third-party maps about the routes.

Example 7 provides the method of any one of examples 1-6, in which determining the profitability score includes estimating a fixed cost for the equipment type, the fixed cost representing a threshold rate irrespective of mileage accepted by at least other carriers having the equipment type; and calculating, for each load, an adjusted rate by subtracting the fixed cost for the equipment type from the posted for the load.

Example 8 provides the method of example 7, in which estimating the fixed cost includes generating a regression model of rate and mileage from a plurality of loads previously logged in the freight management platform for the equipment type, and determining the fixed cost for the equipment type as the rate at zero mileage in the regression model.

Example 9 provides the method of example 7 or 8, in which determining the profitability score further includes calculating, for each load: travel speed, based on a first regression model between estimated speed and travel mileage from a first plurality of loads previously logged into the freight management platform; load travel time, by dividing posted miles by the travel speed; dead head miles, based on relative location of the carrier to load origin; driving speed, based on a second regression model between estimated speed and dead head mileage from a second plurality of loads previously logged into the freight management platform; dead head miles driving time, by dividing the dead head miles by the driving speed; lead time for the load based on a subset of the data relevant to an origin location of the load; total trip time, as a sum of the load travel time, the dead head miles driving time, and the lead time; and the profitability score as ratio of the adjusted rate and the trip total time.

Example 10 provides the method of example 9, in which the load travel time takes into account breaks and hours of service for the load.

Example 11 provides the method of example 9 or 10, in which the first regression model includes hours of service obtained from government regulations where corresponding broker data is not available.

Example 12 provides the method of any one of examples 1-11, in which some loads with higher profitability scores have higher likelihood of being viewed on the loadboard than other loads with lower profitability score.

Example 13 provides the method of any one of examples 1-12, in which: the load recommendation system includes a plurality of microservices performing various calculations, the plurality of microservices communicate with each other over respective application programming interfaces; and at least a subset of the plurality of microservices is coordinated by one or more job schedulers.

Example 14 provides the method of any one of examples 1-13, in which: the user interface is in a frontend executing in a computing device remote from a backend, the backend includes portions of the load recommendation system, and the backend executes in a cloud network.

Example 15 provides the method of any one of examples 1-14, in which the profitability score is updated when the data is updated in the freight management platform.

Example 16 provides the method of any one of examples 1-15, further including filtering the retrieved loads according to the profitability score, in which loads having a lower profitability score than a predetermined threshold value is not displayed.

Example 17 provides the method of any one of examples 1-16, further including sending, by the load recommendation system, a notification including the retrieved loads arranged and filtered according to the profitability scores.

Example 18 provides the method of any one of examples 1-17, further including recommending, based on the profitability scores, a subset of the retrieved loads to the carrier to be undertaken sequentially.

Example 19 provides the method of any one of examples 1-18, further including estimating the carrier's business health based on the profitability score of loads from the displayed loads selected by the carrier for consideration.

Example 20 provides the method of any one of examples 1-19, further including estimating a likelihood of the carrier turning from a lead to a paying customer based on the profitability scores of the retrieved loads.

Example 21 provides non-transitory computer-readable tangible media that includes instructions for execution, which when executed by a processor of a computing device, is operable to perform operations including receiving, at a load recommendation system in a freight management platform, a search query associated with a carrier for loads posted on a loadboard, the search query including at least one filter indicative of an equipment type; retrieving, by the load recommendation system, loads posted on the loadboard that satisfy the search query; retrieving, by the load recommendation system, data logged previously in the freight management platform; determining, by the load recommendation system, a profitability score for each retrieved load based on the data, at least a part of the determining based on a subset of the data relevant to the search query; and displaying, by the load recommendation system on a user interface, the retrieved loads matching the filters in the search query and arranged according to the profitability score, in which: the data includes information on loads, the carrier and other carriers, brokers, and routes, the profitability score represents hourly income for the carrier from the corresponding retrieved load, and the profitability score of any one load varies among different carriers.

Example 22 provides the non-transitory computer-readable tangible media of example 21, in which the data includes preferences, business information, equipment, and historical data of the carrier and other carriers previously logged in the freight management platform.

Example 23 provides the non-transitory computer-readable tangible media of example 21 or 22, in which the data includes posted loads, number of breaks allowed, hours of service permitted, and terms of service associated with brokers as previously logged in the freight management platform.

Example 24 provides the non-transitory computer-readable tangible media of example 23, in which the data is estimated for individual brokers based at least on loads posted by the respective broker and business information of the respective broker.

Example 25 provides the non-transitory computer-readable tangible media of example 23 or 24, in which the data is estimated as an average across a plurality of brokers based at least on the loads posted by the plurality of brokers and business information of the plurality of brokers.

Example 26 provides the non-transitory computer-readable tangible media of any one of examples 21-25, in which the data includes information about routes previously logged by carriers in the freight management platform and information from third-party maps about the routes.

Example 27 provides the non-transitory computer-readable tangible media of any one of examples 21-26, in which determining the profitability score includes estimating a fixed cost for the equipment type, the fixed cost representing a threshold rate irrespective of mileage accepted by at least other carriers having the equipment type; and calculating, for each load, an adjusted rate by subtracting the fixed cost for the equipment type from the posted for the load.

Example 28 provides the non-transitory computer-readable tangible media of example 27, in which estimating the fixed cost includes generating a regression model of rate and mileage from a plurality of loads previously logged in the freight management platform for the equipment type, and determining the fixed cost for the equipment type as the rate at zero mileage in the regression model.

Example 29 provides the non-transitory computer-readable tangible media of example 27 or 28, in which determining the profitability score further includes calculating, for each load: travel speed, based on a first regression model between estimated speed and travel mileage from a first plurality of loads previously logged into the freight management platform; load travel time, by dividing posted miles by the travel speed; dead head miles, based on relative location of the carrier to load origin; driving speed, based on a second regression model between estimated speed and dead head mileage from a second plurality of loads previously logged into the freight management platform; dead head driving time, by dividing the dead head miles by the driving speed; lead time for the load based on a subset of the data relevant to an origin location of the load; total trip time, as a sum of the load travel time, the dead head driving time, and the lead time; and the profitability score as ratio of the adjusted rate and the trip total time.

Example 30 provides the non-transitory computer-readable tangible media of example 29, in which the load travel time takes into account breaks and hours of service for the load.

Example 31 provides the non-transitory computer-readable tangible media of example 29 or 30, in which the first regression model includes hours of service obtained from government regulations where corresponding broker data is not available.

Example 32 provides the non-transitory computer-readable tangible media of any one of examples 21-31, in which some loads with higher profitability scores have higher likelihood of being viewed on the loadboard than other loads with lower profitability score.

Example 33 provides the non-transitory computer-readable tangible media of any one of examples 21-32, in which: the load recommendation system includes a plurality of microservices performing various calculations, the plurality of microservices communicate with each other over respective application programming interfaces; and at least a subset of the plurality of microservices is coordinated by one or more job schedulers.

Example 34 provides the non-transitory computer-readable tangible media of any one of examples 21-33, in which: the user interface is in a frontend executing in a computing device remote from a backend, the backend includes portions of the load recommendation system, and the backend executes in a cloud network.

Example 35 provides the non-transitory computer-readable tangible media of any one of examples 21-34, in which the profitability score is updated when the data is updated in the freight management platform.

Example 36 provides the non-transitory computer-readable tangible media of any one of examples 21-35, in which the operations further include filtering the retrieved loads according to the profitability score, in which loads having a lower profitability score than a predetermined threshold value is not displayed.

Example 37 provides the non-transitory computer-readable tangible media of any one of examples 21-36, in which the operations further include sending, by the load recommendation system, a notification including the retrieved loads arranged and filtered according to the profitability scores.

Example 38 provides the non-transitory computer-readable tangible media of any one of examples 21-37, in which the operations further include recommending, based on the profitability scores, a subset of the retrieved loads to the carrier to be undertaken sequentially.

Example 39 provides the non-transitory computer-readable tangible media of any one of examples 21-38, in which the operations further include estimating the carrier's business health based on the profitability score of loads from the displayed loads selected by the carrier for consideration.

Example 40 provides the non-transitory computer-readable tangible media of any one of examples 21-39, in which the operations further include estimating a likelihood of the carrier turning from a lead to a paying customer based on the profitability scores of the retrieved loads.

Example 41 provides an apparatus including a processing circuitry; a memory storing data; and a communication circuitry, in which the processing circuitry executes instructions associated with the data, the processing circuitry is coupled to the communication circuitry and the memory, and the processing circuitry and the memory cooperate, such that the apparatus is configured for: receiving, at a load recommendation system in a freight management platform, a search query associated with a carrier for loads posted on a loadboard, the search query including at least one filter indicative of an equipment type; retrieving, by the load recommendation system, loads posted on the loadboard that satisfy the search query; retrieving, by the load recommendation system, data logged previously in the freight management platform; determining, by the load recommendation system, a profitability score for each retrieved load based on the data, at least a part of the determining based on a subset of the data relevant to the search query; and displaying, by the load recommendation system on a user interface, the retrieved loads matching the filters in the search query and arranged according to the profitability score, in which: the data includes information on loads, the carrier and other carriers, brokers, and routes, the profitability score represents hourly income for the carrier from the corresponding retrieved load, and the profitability score of any one load varies among different carriers.

Example 42 provides the apparatus of example 41, in which the data includes preferences, business information, equipment, and historical data of the carrier and other carriers previously logged in the freight management platform.

Example 43 provides the apparatus of example 41 or 42, in which the data includes posted loads, number of breaks allowed, hours of service permitted, and terms of service associated with brokers as previously logged in the freight management platform.

Example 44 provides the apparatus of example 43, in which the data is estimated for individual brokers based at least on loads posted by the respective broker and business information of the respective broker.

Example 45 provides the apparatus of example 43 or 44, in which the data is estimated as an average across a plurality of brokers based at least on the loads posted by the plurality of brokers and business information of the plurality of brokers.

Example 46 provides the apparatus of any one of examples 41-45, in which the data includes information about routes previously logged by carriers in the freight management platform and information from third-party maps about the routes.

Example 47 provides the apparatus of any one of examples 41-46, in which determining the profitability score includes estimating a fixed cost for the equipment type, the fixed cost representing a threshold rate irrespective of mileage accepted by at least other carriers having the equipment type; and calculating, for each load, an adjusted rate by subtracting the fixed cost for the equipment type from the posted for the load.

Example 48 provides the apparatus of example 47, in which estimating the fixed cost includes generating a regression model of rate and mileage from a plurality of loads previously logged in the freight management platform for the equipment type, and determining the fixed cost for the equipment type as the rate at zero mileage in the regression model.

Example 49 provides the apparatus of example 47 or 48, in which determining the profitability score further includes calculating, for each load: travel speed, based on a first regression model between estimated speed and travel mileage from a first plurality of loads previously logged into the freight management platform; load travel time, by dividing posted miles by the travel speed; dead head miles, based on relative location of the carrier to load origin; driving speed, based on a second regression model between estimated speed and dead head mileage from a second plurality of loads previously logged into the freight management platform; dead head driving time, by dividing the dead head miles by the driving speed; lead time for the load based on a subset of the data relevant to an origin location of the load; total trip time, as a sum of the load travel time, the dead head driving time, and the lead time; and the profitability score as ratio of the adjusted rate and the trip total time.

Example 50 provides the apparatus of example 49, in which the load travel time takes into account breaks and hours of service for the load.

Example 51 provides the apparatus of example 49 or 50, in which the first regression model includes hours of service obtained from government regulations where corresponding broker data is not available.

Example 52 provides the apparatus of any one of examples 41-51, in which some loads with higher profitability scores have higher likelihood of being viewed on the loadboard than other loads with lower profitability score.

Example 53 provides the apparatus of any one of examples 41-52, in which: the load recommendation system includes a plurality of microservices performing various calculations, the plurality of microservices communicate with each other over respective application programming interfaces; and at least a subset of the plurality of microservices is coordinated by one or more job schedulers.

Example 54 provides the apparatus of any one of examples 41-53, in which: the user interface is in a frontend executing in a computing device remote from a backend, the backend includes portions of the load recommendation system, and the backend executes in a cloud network.

Example 55 provides the apparatus of any one of examples 41-54, in which the profitability score is updated when the data is updated in the freight management platform.

Example 56 provides the apparatus of any one of examples 41-55, in which the apparatus is further configured for filtering the retrieved loads according to the profitability score, in which loads having a lower profitability score than a predetermined threshold value is not displayed.

Example 57 provides the apparatus of any one of examples 41-56, in which the apparatus is further configured for sending, by the load recommendation system, a notification including the retrieved loads arranged and filtered according to the profitability scores.

Example 58 provides the apparatus of any one of examples 41-57, in which the apparatus is further configured for recommending, based on the profitability scores, a subset of the retrieved loads to the carrier to be undertaken sequentially.

Example 59 provides the apparatus of any one of examples 41-58, in which the apparatus is further configured for estimating the carrier's business health based on the profitability score of loads from the displayed loads selected by the carrier for consideration. The apparatus of claim 41, further including estimating a likelihood of the carrier turning from a lead to a paying customer based on the profitability scores of the retrieved loads.

The above description of illustrated implementations of the disclosure, including what is described in the abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

1. A method for load recommendation using profitability scores in a freight management platform, the method comprising:
receiving, at a load recommendation system in the freight management platform, a search query associated with a carrier for loads posted on a loadboard, the search query including at least one filter indicative of an equipment type;
retrieving, by the load recommendation system, loads posted on the loadboard that satisfy the search query;
retrieving, by the load recommendation system, data logged previously in the freight management platform;
determining, by the load recommendation system, a profitability score for each retrieved load based on the data, at least a part of the determining based on a subset of the data relevant to the search query;
comparing the profitability score to a predetermined threshold; and
displaying, by the load recommendation system on a user interface, the retrieved loads having profitability score greater than the predetermined threshold and matching the filters in the search query and arranged according to the profitability score,
wherein:
the data comprises information on loads, the carrier and other carriers, brokers, and routes,
the profitability score represents hourly income from the corresponding retrieved load for the carrier associated with the search query, and
the profitability score of any one load is specific to the carrier associated with the search query and varies among different carriers.

2. The method of claim 1, wherein the data comprises preferences, business information, equipment, and historical data of the carrier and other carriers previously logged in the freight management platform.

3. The method of claim 1, wherein the data comprises posted loads, number of breaks allowed, hours of service permitted, and terms of service associated with brokers as previously logged in the freight management platform.

4. The method of claim 1, wherein the data comprises information about routes previously logged by carriers in the freight management platform and information from third-party maps about the routes.

5. The method of claim 1, wherein determining the profitability score comprises:
estimating a fixed cost for the equipment type of the search query, the fixed cost representing a threshold rate irrespective of mileage accepted by at least other carriers having the equipment type; and
calculating, for each load, an adjusted rate by subtracting the fixed cost for the equipment type from a posted rate for the load.

6. The method of claim 5, wherein estimating the fixed cost comprises:
generating a regression model of rate and mileage from a plurality of loads previously logged in the freight management platform for the equipment type, and
determining the fixed cost for the equipment type as the rate at zero mileage in the regression model.

7. The method of claim 5, wherein determining the profitability score further comprises calculating, for each load:
travel speed, based on a first regression model between estimated speed and travel mileage from a first plurality of loads previously logged into the freight management platform;
load travel time, by dividing posted miles by the travel speed;
dead head miles, based on relative location to load origin of the carrier associated with the search query;
driving speed, based on a second regression model between estimated speed and dead head mileage from a second plurality of loads previously logged into the freight management platform;
dead head miles driving time, by dividing the dead head miles by the driving speed;
lead time for the load based on a subset of the data relevant to an origin location of the load;
total trip time, as a sum of the load travel time, the dead head miles driving time, and the lead time; and
the profitability score as ratio of the adjusted rate and the trip total time.

8. The method of claim 1, wherein some loads with higher profitability scores have higher likelihood of being viewed on the loadboard than other loads with lower profitability score.

9. Non-transitory computer-readable tangible media that includes instructions for execution, which when executed by a processor of a computing device, is operable to perform operations comprising:
receiving, at a load recommendation system in a freight management platform, a search query associated with a carrier for loads posted on a loadboard, the search query including at least one filter indicative of an equipment type;
retrieving, by the load recommendation system, loads posted on the loadboard that satisfy the search query;
retrieving, by the load recommendation system, data logged previously in the freight management platform;
determining, by the load recommendation system, a profitability score for each retrieved load based on the data, at least a part of the determining based on a subset of the data relevant to the search query;
comparing the profitability score to a predetermined threshold; and
displaying, by the load recommendation system on a user interface, the retrieved loads having profitability score greater than the predetermined threshold and matching the filters in the search query and arranged according to the profitability score,
wherein:
the data comprises information on loads, the carrier and other carriers, brokers, and routes,
the profitability score represents hourly income for the carrier from the corresponding retrieved load for the carrier associated with the search query, and
the profitability score of any one load is specific to the carrier associated with the search query and varies among different carriers.

10. The non-transitory computer-readable tangible media of claim 9, wherein the data comprises posted loads, number of breaks allowed, hours of service permitted, and terms of service associated with brokers as previously logged in the freight management platform.

11. The non-transitory computer-readable tangible media of claim 10, wherein the data is estimated for individual brokers based at least on loads posted by the respective broker and business information of the respective broker.

12. The non-transitory computer-readable tangible media of claim 10, wherein the data is estimated as an average across a plurality of brokers based at least on the loads posted by the plurality of brokers and business information of the plurality of brokers.

13. The non-transitory computer-readable tangible media of claim 9, wherein determining the profitability score comprises:
estimating a fixed cost for the equipment type of the search query, the fixed cost representing a threshold rate irrespective of mileage accepted by at least other carriers having the equipment type; and
calculating, for each load, an adjusted rate by subtracting the fixed cost for the equipment type from a posted rate for the load.

14. The non-transitory computer-readable tangible media of claim 13, wherein determining the profitability score further comprises calculating, for each load:
travel speed, based on a first regression model between estimated speed and travel mileage from a first plurality of loads previously logged into the freight management platform;
load travel time, by dividing posted miles by the travel speed;
dead head miles, based on relative location to load origin of the carrier associated with the search query;
driving speed, based on a second regression model between estimated speed and dead head mileage from a second plurality of loads previously logged into the freight management platform;
dead head driving time, by dividing the dead head miles by the driving speed;
lead time for the load based on a subset of the data relevant to an origin location of the load;
total trip time, as a sum of the load travel time, the dead head driving time, and the lead time; and
the profitability score as ratio of the adjusted rate and the trip total time.

15. The non-transitory computer-readable tangible media of claim 9, wherein:
the load recommendation system comprises a plurality of microservices performing various calculations,
the plurality of microservices communicate with each other over respective application programming interfaces; and
at least a subset of the plurality of microservices is coordinated by one or more job schedulers.

16. An apparatus comprising:
a processing circuitry;
a memory storing data; and
a communication circuitry, wherein the processing circuitry executes instructions associated with the data, the processing circuitry is coupled to the communication circuitry and the memory, and the processing circuitry and the memory cooperate, such that the apparatus is configured for:
receiving, at a load recommendation system in a freight management platform, a search query associated with a carrier for loads posted on a loadboard, the search query including at least one filter indicative of an equipment type;
retrieving, by the load recommendation system, loads posted on the loadboard that satisfy the search query;
retrieving, by the load recommendation system, data logged previously in the freight management platform;
determining, by the load recommendation system, a profitability score for each retrieved load based on the data, at least a part of the determining based on a subset of the data relevant to the search query;
comparing the profitability score to a predetermined threshold; and
displaying, by the load recommendation system on a user interface, the retrieved loads having profitability score greater than the predetermined threshold and matching the filters in the search query and arranged according to the profitability score,
wherein:
the data comprises information on loads, the carrier and other carriers, brokers, and routes,
the profitability score represents hourly income for the carrier from the corresponding retrieved load for the carrier associated with the search query, and
the profitability score of any one load is specific to the carrier associated with the search query and varies among different carriers.

17. The apparatus of claim 16, wherein determining the profitability score comprises:
estimating a fixed cost for the equipment type of the search query, the fixed cost representing a threshold rate irrespective of mileage accepted by at least other carriers having the equipment type; and
calculating, for each load, an adjusted rate by subtracting the fixed cost for the equipment type from a posted rate for the load.

18. The apparatus of claim 17, wherein determining the profitability score further comprises calculating, for each load:
travel speed, based on a first regression model between estimated speed and travel mileage from a first plurality of loads previously logged into the freight management platform;
load travel time, by dividing posted miles by the travel speed;
dead head miles, based on relative location to load origin of the carrier associated with the search query;
driving speed, based on a second regression model between estimated speed and dead head mileage from a second plurality of loads previously logged into the freight management platform;
dead head driving time, by dividing the dead head miles by the driving speed;
lead time for the load based on a subset of the data relevant to an origin location of the load;
total trip time, as a sum of the load travel time, the dead head driving time, and the lead time; and
the profitability score as ratio of the adjusted rate and the trip total time.

19. The apparatus of claim 16, wherein:
the user interface is in a frontend executing in a computing device remote from a backend,
the backend comprises portions of the load recommendation system, and
the backend executes in a cloud network.

20. The apparatus of claim 16, wherein the profitability score is updated when the data is updated in the freight management platform.
